(19) United States
(12) Patent Application Publication
(10) Pub. No.: US 2014/0310600 A1
(43) Pub. Date: Oct. 16, 2014

(54) SYSTEM AND METHOD FOR CHANGING LIVE MEDIA CONTENT CHANNELS

(71) Applicant: FANHATTAN LLC, San Mateo, CA (US)

(72) Inventors: Gilles Serge BianRosa, Redwood City, CA (US); Olivier Chalouhi, Redwood City, CA (US); Gregory Smelzer, San Mateo, CA (US)

(73) Assignee: Fanhattan LLC, San Mateo, CA (US)

(21) Appl. No.: 13/862,189

(22) Filed: Apr. 12, 2013

(51) Int. Cl. G06F 3/0488

(52) U.S. Cl. CPC G06F 3/0488
USPC 715/719

(57) ABSTRACT

A first display comprising a first live media content of a first media channel is generated. Input data are detected from a touch-enabled surface. A second display is caused to traverse over the first display in response to the input data. The second display, during traverse, comprises a description of a second live media content of a second media channel and a background picture of the second live media content. The second live media content of the second media channel is generated in the second display.

### TECHNICAL FIELD

Example embodiments of the present application generally relate to media content, and more specifically, to a system and method for changing live media content channels.

### BACKGROUND

Navigating among a vast sea of content is a particularly difficult and burdensome task for a user. Today's user interfaces and search engines offer some insights and approaches to navigating among content, but often these interfaces and search engines are designed to navigate among content in a rigid manner.

### BRIEF DESCRIPTION OF DRAWINGS

The embodiments disclosed in the present disclosure are illustrated by way of example, and not by way of limitation, in the figures of the accompanying drawings. Like reference numerals refer to corresponding parts throughout the drawings.

FIG. 1 is a block diagram illustrating a network system having an architecture configured for exchanging data over a network, according to some embodiments.

FIG. 2 is a block diagram illustrating modules of an application, according to some embodiments.

FIG. 3 is a flow diagram illustrating an example method for changing live media content channels, according to some embodiments.

FIG. 4 is a flow diagram illustrating another example method for changing live media content channels, according to some embodiments.

FIG. 5 is a diagram of an example user interface for displaying a first live media content in a first display, according to some embodiments.

FIG. 6 is a diagram of an example user interface for displaying a second display being drag on top of the first display.

FIG. 7 is a diagram of another example user interface for displaying a second display being drag on top of the first display.

FIG. 8 is a diagram of an example user interface for displaying the second display replacing the first display.

FIG. 9 is a diagram of an example user interface for displaying a second live media content in a second display, according to some embodiments.

FIG. 10 shows a diagrammatic representation of a machine in the example form of a computer system.

FIGS. 11-15 show screenshots of examples of a user interface for changing live media content channels.

### DETAILED DESCRIPTION

Although the disclosure has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

In various embodiments, a system and method for changing live media content channels is disclosed. A first display comprising a first live media content of a first media channel is generated. Input data are detected from a touch-enabled surface. A second display is caused to traverse over the first display in response to the input data. The second display, during traverse, comprises a description of a second live media content of a second media channel. The second live media content of the second media channel is generated in the second display.

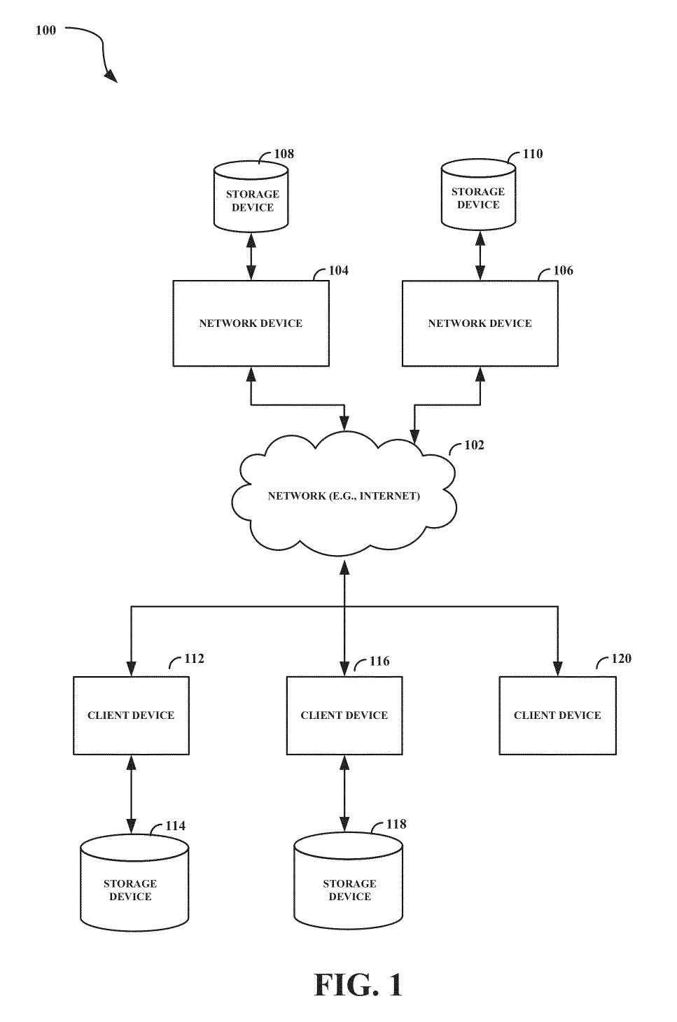

FIG. 1 is a block diagram illustrating an example network system 100 connecting one or more client devices 112, 116, and 120 to one or more network devices 104 and 106 via a network 102. The one or more client devices 112, 116, and 120 may include Internet- or network-enabled devices, such as consumer electronics devices (e.g., televisions, DVD players, Blu-Ray® players, set-top boxes, portable audio/video players, gaming consoles) and computing devices (e.g., personal computer, laptop, tablet computer, smart phone, mobile device). The type of client devices is not intended to be limiting, and the foregoing devices listed are merely examples. The client devices 112, 116, and 120 may have remote, attached, or internal storage devices 114, 118. For illustrative purposes only, although client devices 112 and 116 are shown in FIG. 1 as having connected storage devices 114 and 118, respectively, and client device 120 is shown without a connected storage device, in some embodiments, each client device 112, 116, and 120 may have local access to one or more storage or memory devices.

In some embodiments, one or more of the client devices 112, 116, and 120 may have installed thereon and may execute a client application (not shown) that enables the client device to serve as a local media server instance. The client application may search for and discover media content (e.g., audio, video, images) stored on the device as well as media content stored on other networked client devices having the client application installed thereon. The client application may aggregate the discovered media content, such that a user may access local content stored on any client device having the client application installed thereon. In some embodiments, the aggregated discovered media content may be separated by device, such that a user is aware of the network devices connected to a particular device and the content stored on the connected network devices. In some embodiments, each connected network device may be represented in the application by an indicator, such as an icon, an image, or a graphic. When a connected network device is selected, the indicator may be illuminated or highlighted to indicate that that particular network device is being accessed.

In some embodiments, the discovered media content may be stored in an aggregated data file, which may be stored on the client device. The local content may be indexed by the client device in which the content resides. The client application also may aggregate and present a variety of remote sources to the user from which the user is able to download, stream, or otherwise access a particular media content item. For example, the client application may present to the user all streaming, rental, and purchase options for a particular media content item to the extent they exist and are available for access.

One or more network devices 104 and 106 may be communicatively connected to the client devices 112, 116, and 120 via network 102. In some embodiments, the network devices 104 and 106 may be servers storing media content or metadata relating to media content available to be accessed by the client devices 112, 116, and 120. In some embodiments, the network devices 104 and 106 may include proprietary servers related to the client application as well as third party servers hosting free or subscription-based content. Additional third-party servers may include servers operating as metadata repositories and servers hosting electronic commerce sites. For example, in the context of movies, third-party servers may be servers associated with the themoviedb.org and other third-party aggregators that store and deliver movie metadata in response to user requests. In some embodiments, some of the third-party servers may host websites offering merchandise related to a content item for sale. The network devices 104 and 106 may include attached storage devices or may interface with databases or other storage devices 108 and 110. For illustrative purposes only, the network devices 104 and 106 each have been shown as a single device in FIG. 1, although it is contemplated that the network devices 104 and 106 may include one or more web servers, application servers, database servers, and so forth, operating independently or in conjunction to store and deliver content via network 102.

In some embodiments where one or more of the network devices 104 and 106 are proprietary servers associated with the client application, the proprietary servers may store metadata related to media content and data that facilitates identification of media content across multiple content servers. For example, the proprietary servers may store identifiers for media content that are used to interface with third party servers that store or host the media content. The proprietary servers further may include one or more modules capable of verifying the identity of media content and providing access information concerning media content (e.g., the source(s) of media content, the format(s) of media content, the availability of media content).

The client application installed on one or more of the client devices 112, 116, and 120 may enable a user to search for media content or navigate among categories of media content. To find media content, a user may enter search terms in a user interface of the client application to retrieve search results, or the user may select among categories and sub-categories of media content to identify a particular media content item. For each browsed content item, the client application may display metadata associated with the content item. The metadata may be retrieved from both local and remote sources. The metadata may include but are not limited to a title of the content item, one or more images (e.g., wallpapers, backgrounds, screenshots) or video clips related to the content item, a release date of the content item, a cast of the content item, one or more reviews of the content item, and release windows and release dates for various distribution channels for the browsed content item.

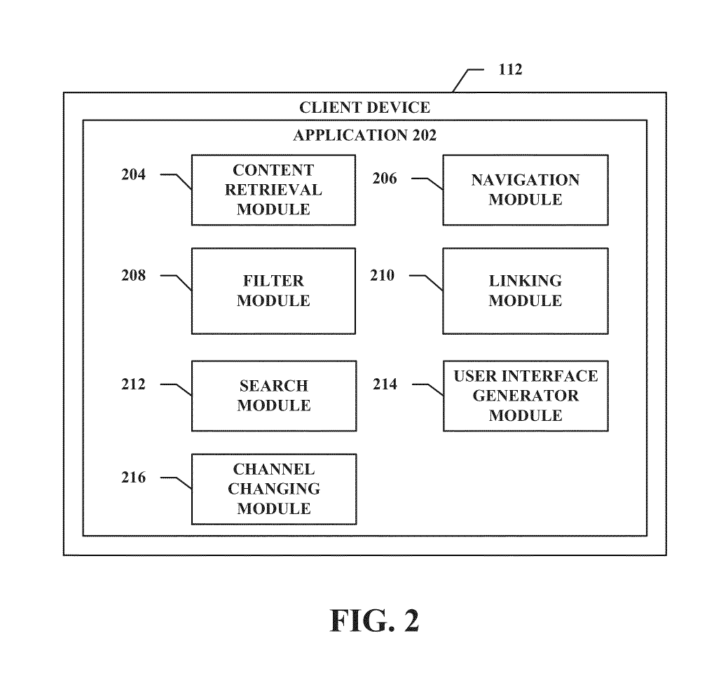

FIG. 2 is a block diagram illustrating modules of an application, according to some embodiments. Although the modules are shown in FIG. 2 as being part of a client device, it is contemplated that the modules may be implemented on a network device, such as a server. In an example embodiment, the application 202 may be the client application discussed with reference to FIG. 1. In an example embodiment, one or more processors of a client device or a network device may execute or implement the modules.

The application 202 includes modules, such as a content retrieval module 204, a navigation module 206, a filter module 208, a linking module 210, a search module 212, a user interface generator module 214, and a channel changing module 216 to perform operations, according to some embodiments.

The content retrieval module 204 may retrieve content and content-related data from networked devices, such as content sources and metadata repositories. Content sources may include both locally networked sources (e.g., other networked devices executing the application 202) and remote sources, such as third party content providers. In some embodiments, the content retrieval module 204 may retrieve metadata related to content items and may use the metadata to populate a user interface with information related to content items, such as movies and television programs. For example, the content retrieval module 204 may retrieve metadata such as a content titles, cover art, screenshots, content descriptions, plot synopses, and cast listings. In some embodiments, the metadata may be displayed as part of listings of content presented to a user during application navigation and search operations. For example, the metadata may be displayed when a user is navigating among categories of content or is searching for a particular content item. Each content item discovered during navigation or searching may be populated with the retrieved metadata. In some embodiments, metadata is retrieved on an as-needed basis. To reduce the number of data requests and conserve processing and bandwidth resources, metadata may be retrieved when a user navigates to a previously un-traversed portion of the user interface or when the displayed content changes due to a change in search or filtering criteria, among other things. In some embodiments, an AJAX or JSON call is executed to retrieve metadata from local or remote sources.

The navigation module 206 facilitates navigation and browsing of content made available by the application 202. The navigation module 206 may operate in one or more modes. In a carousel navigation mode, the navigation module 206 may provide a user with the ability to easily and efficiently switch the contexts by which content is navigated. For example, a first user interface panel may display a first context by which content items may be browsed. The first context may comprise filtering criteria related to “Top Movies.” Under the heading of “Top Movies,” the navigation module 206 may provide one or more sub-filters by which content may be browsed and surfaced. As a user traverses the sub-filters, content items displayed in a different portion of the user interface may change to reflect the changing criteria by which the content is being browsed. In some embodiments, the sub-filters for a heading of “Top Movies” may include but are not limited to “Hottest,” “Newest,” “Top Rated,” “Critics Picks,” and “Top Free.” The user interface panel may be designed to be traversed by directional arrows of a remote control or keyboard, by an input/output device, or by a touch-based computing device.

If the first user interface panel does not provide the context by which a user desires to navigate among content, the user may easily switch contexts by traversing in a left or right direction to a different context. The different context may be presented in its own user interface panel with selectable and traversable sub-filters or sub-contexts provided within the panel to filter the content items displayed in the content display portion of the user interface. For example, if a user cannot find a content item he wants to view in the “Top Movies” context, the user may change contexts to a “Genre” context. At the new context, the user may navigate among different genres and surface content items related to the selected genre.

The ease in which contexts may be switched is made possible by the fact that at any point in the context panel, the user may traverse right or left to switch contexts. In other words, the user is not required to return to a starting point in the user interface to switch contexts. The carousel nature of context switching is illustrated by the ability for a user to traverse right or left and have different context panels rotate and be presented in the user interface for navigating among content. Thus, the carousel nature of context switching enables a user to navigate among two hierarchies of content using four directions (e.g., up, down, left, right). For touch-enabled computing devices, navigation may be accomplished using touch-based gestures, such as horizontal and vertical swipes and taps.

In a second navigation mode, the navigation module 206 may facilitate a pyramidal navigation of content. Content may be presented to the user in a reverse pyramid hierarchy, with broad categories of content or aggregated content presented at a top-most level. In some embodiments, the top-most level may correspond with the carousel context switching panels. As a user traverses downward through the top-most level and reaches the last sub-element of the top-most level, the user may navigate from the top-most level to a middle-tiered level. In some embodiments, the middle-tiered level may feature one or more displayed content items. In some embodiments, the one or more content items first may be displayed in a lower portion of the user interface. Upon traversing from the top-most level to the middle-tier level, the content items may transition from the lower portion of the user interface to the upper portion of the user interface. Thus, the content items may displace the top-most level user interface panels. In conjunction with such displacement, replacing the content items in the lower portion of the user interface may be a set of user interface panels containing details for an individual content item. A user may traverse left and right to navigate among the content items, and as the traversal occurs, the content item detail panels may be populated with information about the selected content item.

A further hierarchical traversal of content may occur when a user traverses from the middle-tiered level depicting content items to a bottom-tiered level depicting details about a particular content item. In some embodiments, the bottom-tiered level may feature one or more panels devoted to different details or aspects of the content item. In some embodiments, such panels may include a content item description panel, a cast panel listing the cast of the content item, a content source panel from which the content item may be viewed, a merchandise panel featuring merchandise related to the content item, a reviews panel featuring reviews of the content item, and a similar content items panel. The user may navigate between panels using motions in a first axis (e.g., horizontal motions, such as left and right arrow selections, horizontally-directed gestures). At any panel, if the user selects one of the items displayed in the panel (e.g., a cast member, a merchandise item, a similar content item), the user may be directed to a new hierarchy involving the selected item. Thus, in this sense, the pyramidal navigation may begin anew and may not be bounded by a start and an end point.

A third navigational mode supported by the navigation module 206 may entail a power browsing mode whereby content may be browsed via a multi-dimensional search. A user interface panel may be presented with sub-categories and options within each sub-category. As a user proceeds through the panel and selects a sub-category and a choice within the sub-category, content items meeting the filtering criteria may be surfaced and displayed. As a user makes selections in multiple sub-categories, a multi-dimensional navigation mode is attained, thereby more quickly surfacing content items than performing a single dimension search.

For example, a user first may select a sub-category “genre” and within the “genre” sub-category, the user may decide to select the “action and adventure,” “classics,” and “sci-fi and fantasy” genres. Accordingly, content items falling within any of the three selected genres may be displayed in the user interface. A user then may traverse downward in the power browsing panel to the next sub-category. In this example embodiment, the sub-category may be “user ratings.” The user may select “2 or more stars,” in which case only those content items falling within one of the three selected genres and having a user rating of 2 or more stars may be displayed. The user may continue traversing down the power browsing panel and select a sub-category “release date,” and within the sub-category “release date,” the user may select “1990s.” Thus, only content items falling within the three selected genres having a user rating of 2 or more stars and a release date in the 1990s may be surfaced and displayed. The user may continue traversing the power browsing panel and adding additional dimensions to the filter in order to find the most relevant content items meeting the user's desired filter criteria. Once satisfied, the user may traverse to the displayed content items and select a particular content item for browsing and/or viewing.

A fourth navigational mode supported by the navigation module 206 may be pivot navigation, in which a user may use any piece of data related to a content item as a pivot to discover data related to the data pivot. For example, if a user is browsing a particular content item and views the cast of the item, the user may select a particular cast member and use that cast member as a pivot point. At that point, the focus of the user interface may switch from the content item to the cast member. The user may then select a different content item featuring the cast member. That different content item may become the next pivot point for the user to discover related data. Thus, the user may browse among content-related data using specific data items as pivot points by which to discover additional related data.

While four navigational modes have been discussed herein, one of ordinary skill in the art should appreciate that, at any given state of the application, more than one navigation mode may be used together. In other words, the four navigational modes described herein are not to be considered as mutually exclusive navigational modes.

The filter module 208 may store and supply filters to the navigation module 206 for use in helping a user sort through content to identify specific content items of interest. In some embodiments, the filters may be pre-determined, while in some embodiments, the filters may be customized, such as for example, by the user. The filter module 208 also may receive filtering criteria selections from a user and may perform comparisons between the filtering criteria and metadata related to content items. In some embodiments, the filter module 208 may operate in conjunction with the content retrieval module 204 to retrieve only those content items meeting the filtering criteria. For example, in some embodiments, the filter module 208 may determine based on comparisons of metadata which content items meet the filtering criteria. The filter module 208 may pass the content items meeting the filtering criteria to the content retrieval module 204 for retrieval.

The linking module 210 may maintain one or more data structures that store links between content items and content item-related data. The links may facilitate pivot navigation among disparate pieces of data. In some embodiments, the linking module 210 may examine metadata related to content items to determine if any piece of metadata in one content item overlaps or is related to a piece of metadata from another content item. If an association between metadata of two content items exists, the linking module 210 may store the link between the two pieces of metadata. In some embodiments, the linking module 210 also may perform a link lookup when a user selects a content item-related piece of data. The link lookup may identify all data linked to the selected data. The identified data may be provided to other modules, such as the navigation module 206, to ensure a seamless pivot navigation experience.

The search module 212 provides an additional mechanism by which a user may discover content. In some embodiments, the search module 212 may include a front-facing search engine component that permits users to enter search queries and retrieve relevant content. In some embodiments, the search module 212 may include a back-end component that performs a search of stored content items and/or content item metadata to identify relevant search results. The search results may be identified in response to a search query or in response to navigation of content by the user.

The user interface generator module 214 generates one or more user interfaces for the application 202. The user interfaces enable a user to browse, search, and navigation among content items. In some embodiments, the user interface generator module 214 may generate a series of user interfaces corresponding to each navigational mode provided by the navigation module 206, as described with reference to the discussion of the navigation module 206.

The channel changing module 216 facilitates changing live media content channel made available by the application 202. The channel changing module 216 may provide a user with the ability to easily and efficiently change or switch live media content channels. For example, the application 202 may generate a display of a live media content from a first media channel. The user may wish to switch channels by peeking at a description of a live content of a second channel without leaving the display of the live media content of the first media channel. For example, while the user is watching a live sports event, the user can peek into the second media channel by swiping a touch-enabled surface to move or traverse a display of the second media channel over a portion of the display of the live sports event. The display of the second media channel may include an identifier of the channel and a description of the live media content of the second media channel. In one embodiment, the display of the second media channel may include a background poster or picture representative of the live media content of the second media channel. Once the display of the second media channel covers, overlaps, or replaces the display of the live media content of the first media channel, the live media content corresponding to the second media channel is retrieved. The background poster or picture and the description of the live media content are then removed and replaced with the live media content of the second media channel.

In another embodiment, the channel changing module 216 generates a first panel comprising the first live media content of the first media channel, generates a second panel comprising a description of the second live media content of the second media channel, and causes the second panel to traverse over the first panel and cover the first panel in response to the input data.

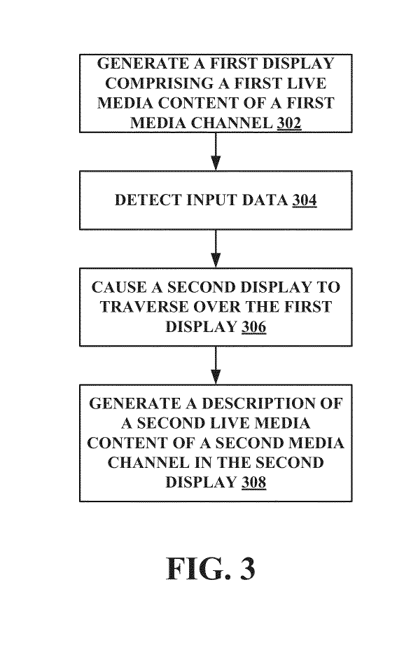

FIG. 3 is a flow diagram illustrating an example method 300 for switching live media content channels, according to some embodiments. Referring to FIG. 3, at block 302, a first display comprising a first live media content of a first media channel is generated. The live media content may be streamed through a computer network such as the internet or via other means, such as over the air antenna or cable. The live media content may include for example, audio, video, and sound of a live programming associated with the first media channel.

At block 304, input data from a touch-enabled surface is detected. For example, the touch-enabled surface may be part of a remote control. In another embodiment, the touch-enabled surface may be part of a display for showing the live media channels. The input data may include data pertaining to a gesture performed by a user on the touch-enabled surface of a remote control device, a display, or from an edge of the touch-enabled surface.

At block 306, the second display traverses over the first display in response to the input data. In one embodiment, the channel changing module 216 causes the second display to traverse over the first display in the direction corresponding to a movement on the touch-enabled surface. At block 308, during the traverse, the second display includes a description of a second live media content of a second media channel. In one embodiment, during the traverse over the first display, the second display comprises a background image associated with the second live media content of the second media channel and an identifier of the second media channel (e.g., channel ABC).

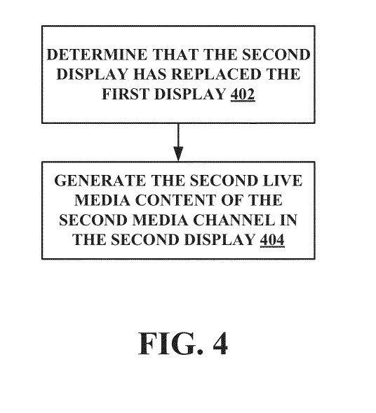

FIG. 4 is a flow diagram illustrating an example method 400 for switching live media content channels, according to some embodiments. The channel changing module 216 determines that the second display has replaced the first display at block 402. Once the first display has been replaced with the second display, the second live media content of the second media channel is retrieved and generated in the second display at block 404.

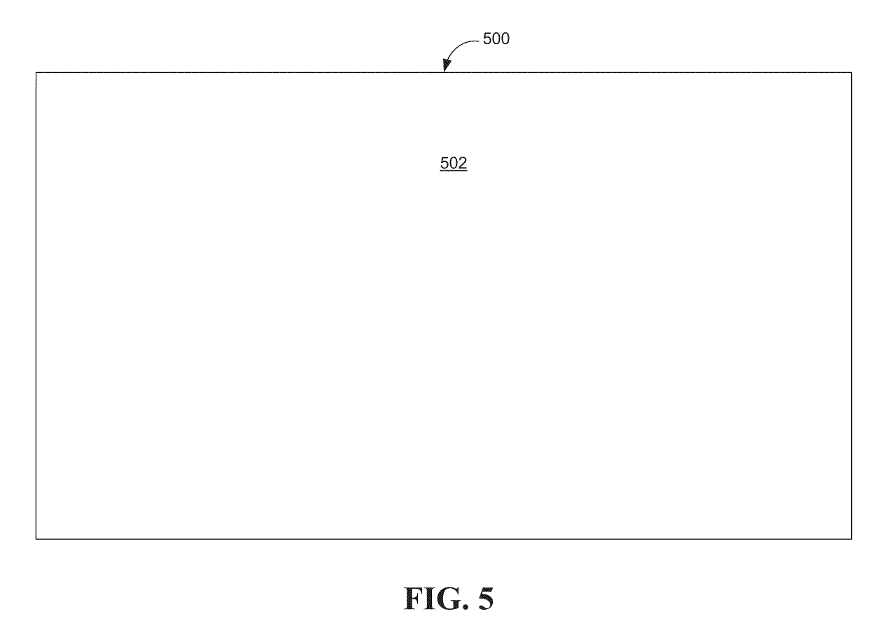

FIG. 5 is a diagram of an example user interface for displaying first live media content 502 in a first display 500, according to some embodiments. For example, the first live media content 502 may include a streaming video from a live programming.

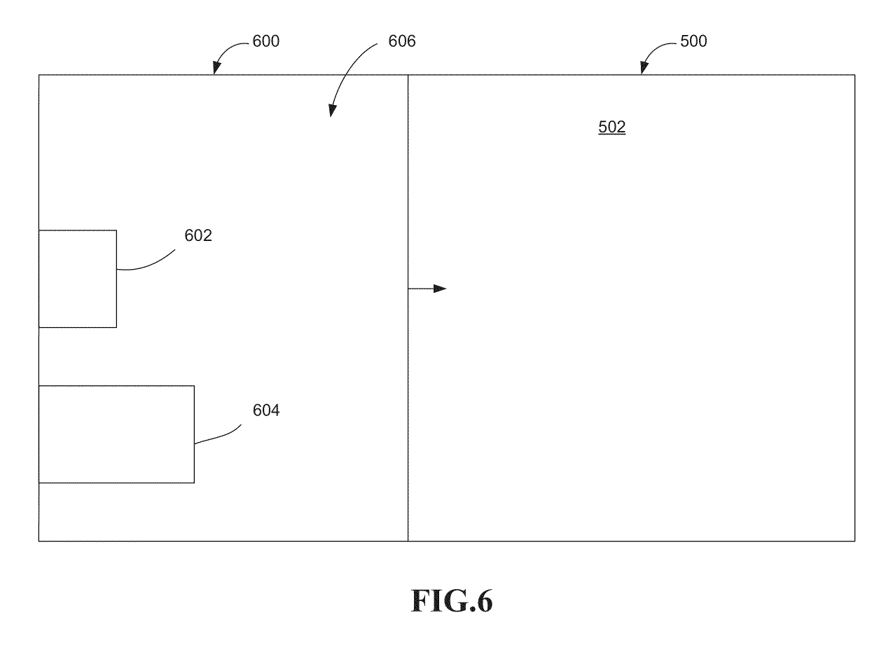

FIG. 6 is a diagram of an example user interface for displaying a second display 600 being dragged on top of the first display 500. The second display 600 may include media channel identifier 602 (e.g., channel ABC), a description 604 of a live media content from the corresponding media channel identifier 602, and a background picture 606 associated with the live media content from the corresponding media channel identifier 602. For example, the description 604 may include a title and a short summary of a live video programming on the corresponding channel. In one embodiment, the description 604 may be accessed or retrieved from a server associated with the channel or from a database storing information about live media content programming.

In one embodiment, the first live media content 502 continues to be streamed while the second display 600 is being dragged on top of the first display 500. For example, the first live media content 502 does not pause while the second display 600 is being moved across the first display 500.

In another embodiment, the second display 600 includes a video of the second live media content of the second media channel instead of the background picture 606. For example, the second display 600 may include a live feed of a live programming of the second media channel while it is being dragged across the first display 500. In other words, the second display 600 may include a dynamic live video instead of a static picture.

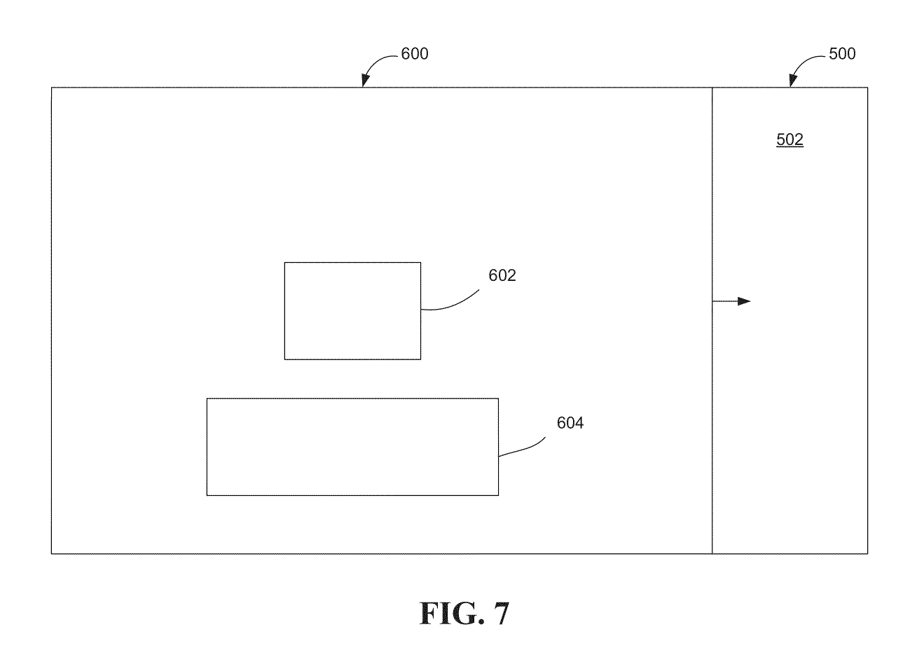

FIG. 7 is a diagram of another example user interface for generating the second display 600 being dragged on top of the first display 500 in response to a user input.

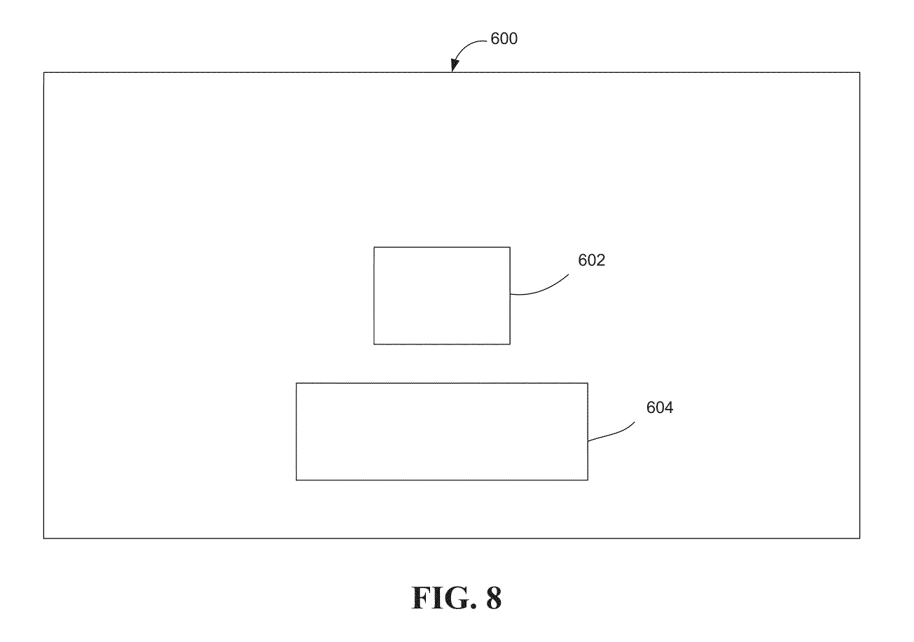

FIG. 8 is a diagram of an example user interface for generating the second display 600 to replace the first display 500 in response to the user input.

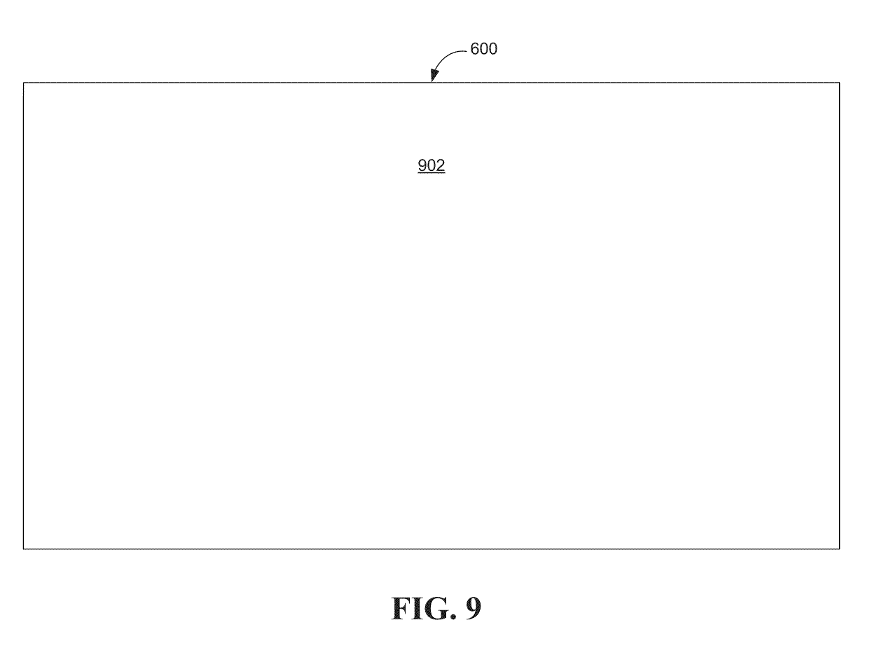

FIG. 9 is a diagram of an example user interface for displaying second live media content 902 in the second display 600, according to some embodiments. The second live media content 902 may include a video being streamed from a live programming.

It should be appreciated that the dimensions and placement of the user interfaces and its elements as depicted in the foregoing embodiments are not to be construed as limiting for the purposes of the discussion herein.

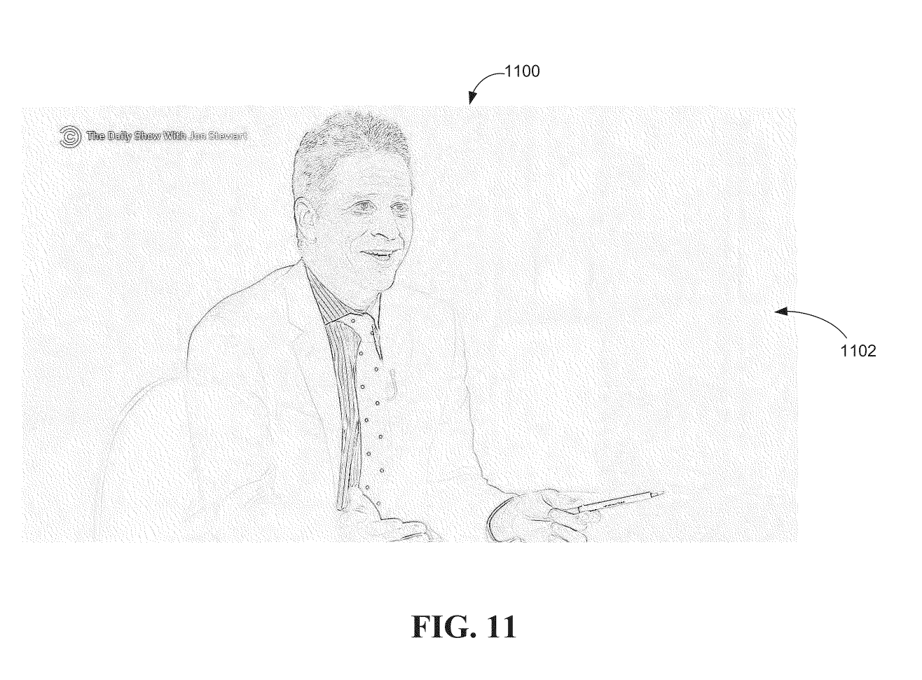

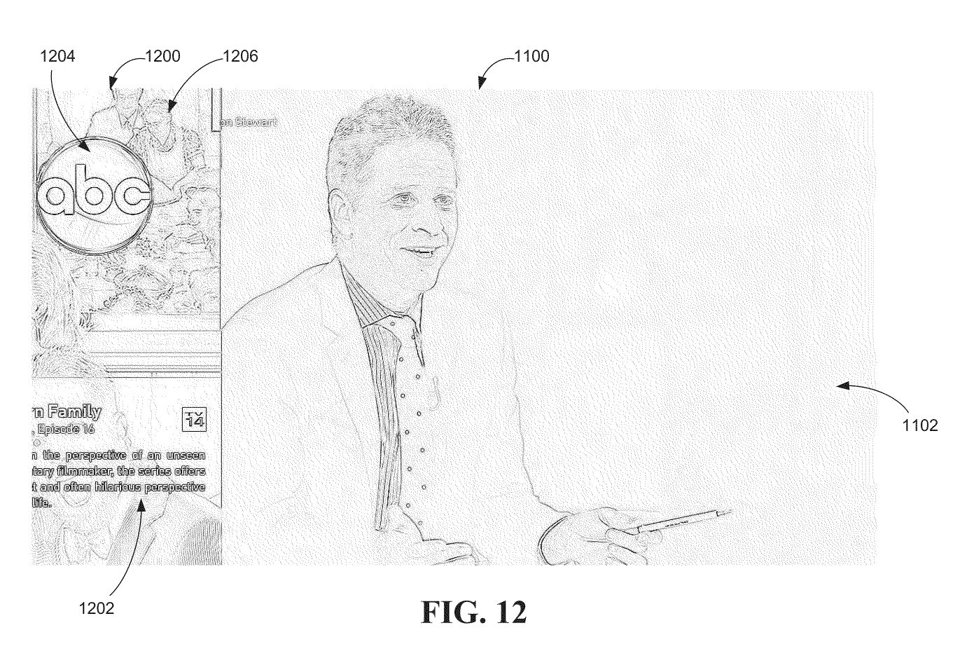

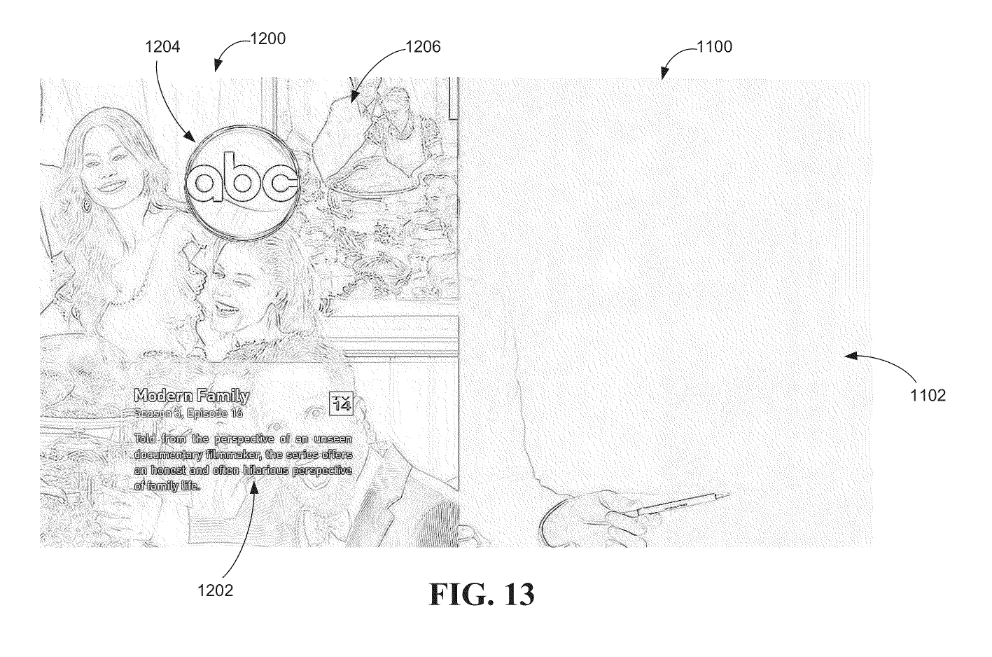

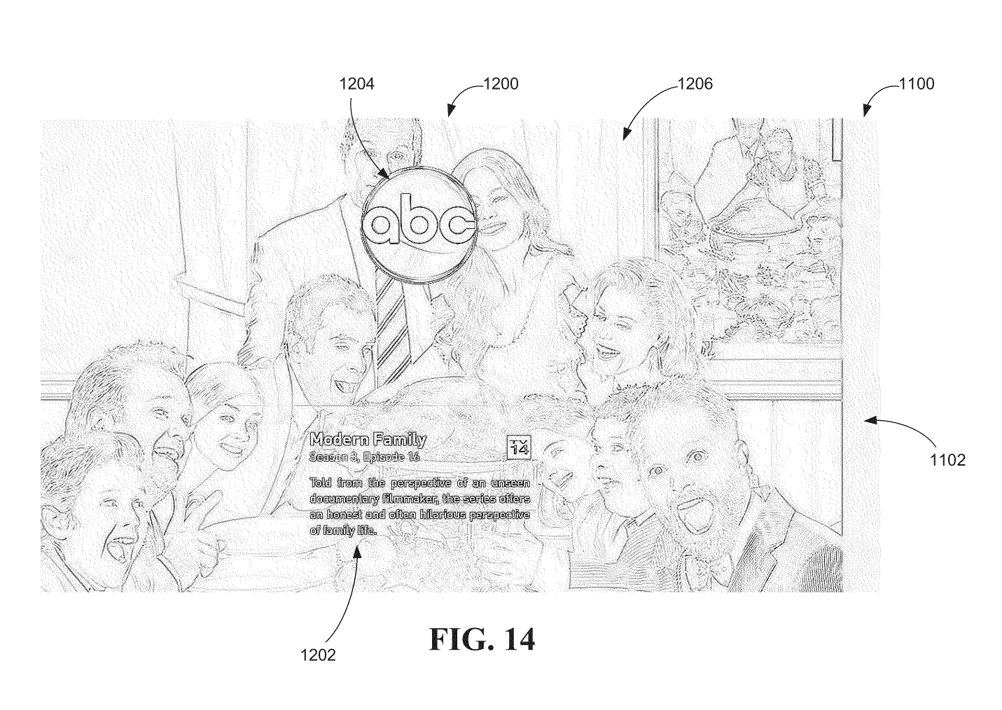

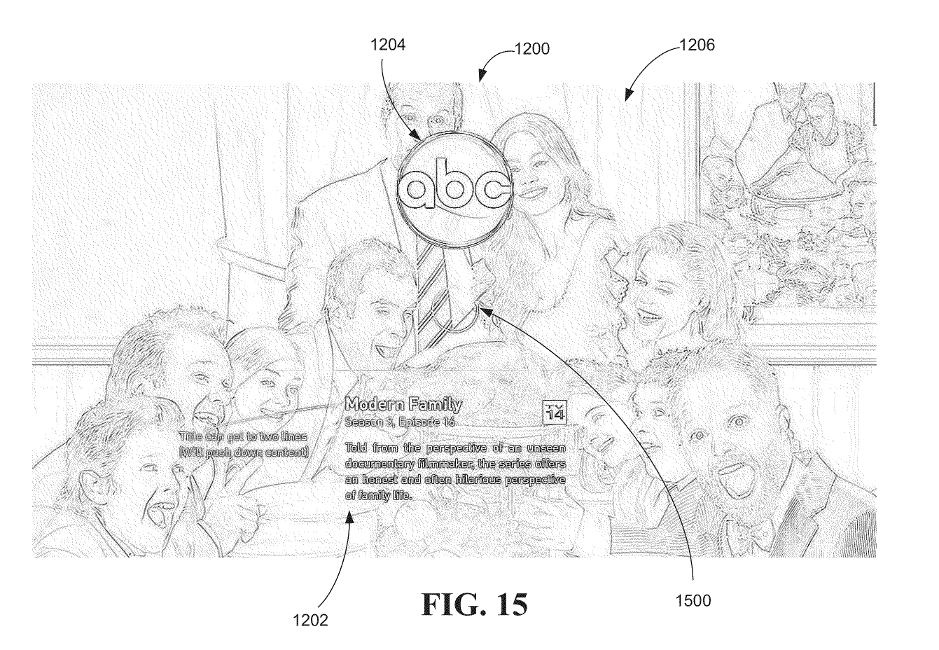

FIGS. 11-15 show screenshots of examples of a user interface for changing live media content channels. A first display 1100 includes live media content 1102 being played. A second display 1200 includes a channel identifier 1204, a description 1202 of a live programming on the corresponding channel, and a background picture 1206 representing the live programming. While the second display 1200 is traversing the first display 1100, the live media content 1102 keeps playing in the first display 1100. When the second display 1200 completely replaces the first display 1100 as illustrated in FIG. 15, the live media content corresponding to the second display 1200 is retrieved. An indicator 1500 may be shown on the second display 1200 to indicate a user that the live media content is being retrieved. Once the live media content has been retrieved, the second display 1200 starts streaming the live media content.

### Modules, Components and Logic

Certain embodiments are described herein as including logic or a number of components, modules, or mechanisms. A component or module is a non-transitory and tangible unit capable of performing certain operations and may be configured or arranged in a certain manner. In example embodiments, one or more computer systems (e.g., a standalone, client or server computer system) or one or more components of a computer system (e.g., a processor or a group of processors) may be configured by software (e.g., an application or application portion) as a component that operates to perform certain operations as described herein.

In various embodiments, a component or a module may be implemented mechanically or electronically. For example, a component or a module may comprise dedicated circuitry or logic that is permanently configured (e.g., as a special-purpose processor) to perform certain operations. A component or a module also may comprise programmable logic or circuitry (e.g., as encompassed within a general-purpose processor or other programmable processor) that is temporarily configured by software to perform certain operations. It will be appreciated that the decision to implement a component mechanically, in dedicated and permanently configured circuitry, or in temporarily configured circuitry (e.g., configured by software) may be driven by cost and time considerations.

Accordingly, the term “component” or “module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which components or modules are temporarily configured (e.g., programmed), each of the components or modules need not be configured or instantiated at any one instance in time. For example, where the components or modules comprise a general-purpose processor configured using software, the general-purpose processor may be configured as respective different components at different times. Software may accordingly configure a processor, for example, to constitute a particular component or module at one instance of time and to constitute a different component or module at a different instance of time.

Components or modules can provide information to, and receive information from, other components or modules. Accordingly, the described components may be regarded as being communicatively coupled. Where multiple of such components or modules exist contemporaneously, communications may be achieved through signal transmission (e.g., over appropriate circuits and buses) that connect the components or modules. In embodiments in which multiple components or modules are configured or instantiated at different times, communications between such components or modules may be achieved, for example, through the storage and retrieval of information in memory structures to which the multiple components or modules have access. For example, one component or module may perform an operation, and store the output of that operation in a memory device to which it is communicatively coupled. A further component or module may then, at a later time, access the memory device to retrieve and process the stored output. Components or modules may also initiate communications with input or output devices, and can operate on a resource (e.g., a collection of information).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA (field programmable gate array) or an ASIC (application-specific integrated circuit).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination permanently and temporarily configured hardware may be a design choice. Below are set out hardware (e.g., machine) and software architectures that may be deployed, in various example embodiments.

### Example Machine Architecture and Machine-Readable Medium

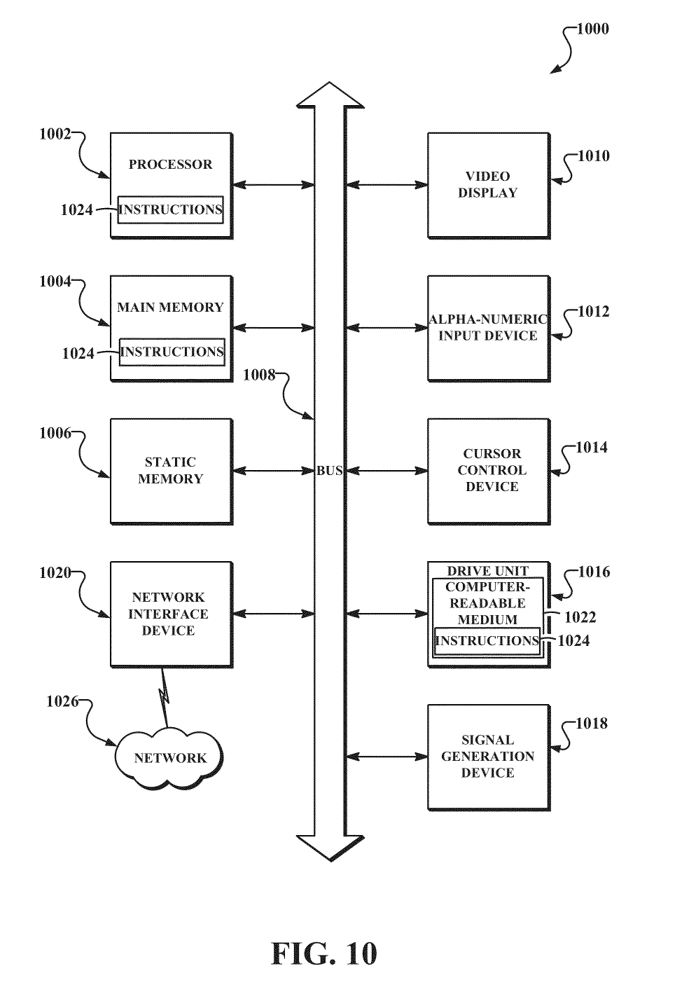

FIG. 10 is a block diagram of machine in the example form of a computer system 1000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes at least one processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions and data structures (e.g., software 1024) embodying or utilized by any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any non-transitory tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

### Transmission Medium

The software 1024 may further be transmitted or received over a communications network 1026 using a transmission medium. The software 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible medium to facilitate communication of such software.

### Example Three-Tier Software Architecture

In some embodiments, the described methods may be implemented using one a distributed or non-distributed software application designed under a three-tier architecture paradigm. Under this paradigm, various parts of computer code (or software) that instantiate or configure components or modules may be categorized as belonging to one or more of these three tiers. Some embodiments may include a first tier as an interface (e.g., an interface tier). Further, a second tier may be a logic (or application) tier that performs application processing of data inputted through the interface level. The logic tier may communicate the results of such processing to the interface tier, and/or to a backend, or storage tier. The processing performed by the logic tier may relate to certain rules, or processes that govern the software as a whole. A third storage tier may be a persistent storage medium or a non-persistent storage medium. In some cases, one or more of these tiers may be collapsed into another, resulting in a two-tier architecture, or even a one-tier architecture. For example, the interface and logic tiers may be consolidated, or the logic and storage tiers may be consolidated, as in the case of a software application with an embedded database. The three-tier architecture may be implemented using one technology, or, a variety of technologies. The example three-tier architecture, and the technologies through which it is implemented, may be realized on one or more computer systems operating, for example, as a standalone system, or organized in a server-client, distributed or so some other suitable configuration. Further, these three tiers may be distributed between more than one computer systems as various components.

### Components

Example embodiments may include the above described tiers, and processes or operations about constituting these tiers may be implemented as components. Common to many of these components is the ability to generate, use, and manipulate data. The components, and the functionality associated with each, may form part of standalone, client, or server computer systems. The various components may be implemented by a computer system on an as-needed basis. These components may include software written in an object-oriented computer language such that a component oriented, or object-oriented programming technique can be implemented using a Visual Component Library (VCL), Component Library for Cross Platform (CLX), Java Beans (JB), Java Enterprise Beans (EJB), Component Object Model (COM), Distributed Component Object Model (DCOM), or other suitable technique.

Software for these components may further enable communicative coupling to other components (e.g., via various Application Programming interfaces (APIs)), and may be compiled into one complete server and/or client software application. Further, these APIs may be able to communicate through various distributed programming protocols as distributed computing components.

### Distributed Computing Components and Protocols

Some example embodiments may include remote procedure calls being used to implement one or more of the above described components across a distributed programming environment as distributed computing components. For example, an interface component (e.g., an interface tier) may form part of a first computer system that is remotely located from a second computer system containing a logic component (e.g., a logic tier). These first and second computer systems may be configured in a standalone, server-client, or some other suitable configuration. Software for the components may be written using the above described object-oriented programming techniques, and can be written in the same programming language, or a different programming language. Various protocols may be implemented to enable these various components to communicate regardless of the programming language used to write these components. For example, a component written in C++ may be able to communicate with another component written in the Java programming language through utilizing a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model, or Transmission Control Protocol/Internet Protocol (TCP/IP) protocol stack model for defining the protocols used by a network to transmit data.

### A System of Transmission Between a Server and Client

Example embodiments may use the OSI model or TCP/IP protocol stack model for defining the protocols used by a network to transmit data. In applying these models, a system of data transmission between a server and client may for example include five layers comprising: an application layer, a transport layer, a network layer, a data link layer, and a physical layer. In the case of software, for instantiating or configuring components, having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. This TCP segment also contains port information for a recipient software application residing remotely. This TCP segment is loaded into the data load field of an IP datagram residing at the network layer. Next, this IP datagram is loaded into a frame residing at the data link layer. This frame is then encoded at the physical layer, and the data transmitted over a network such as an Internet, Local Area Network (LAN), Wide Area Network (WAN), or some other suitable network. In some cases, Internet refers to a network of networks. These networks may use a variety of protocols for the exchange of data, including the aforementioned TCP/IP, and additionally ATM, SNA, SDI, or some other suitable protocol. These networks may be organized within a variety of topologies (e.g., a star topology), or structures.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system, comprising:
at least one processor;
a channel changing module, implemented by the at least one processor, configured to:
generate a first display comprising a first live media content of a first media channel;
detect input data from a touch-enabled surface;
cause a second display to traverse over the first display in response to the input data, the second display, during traverse, comprising a description of a second live media content of a second media channel; and
generate the second live media content of the second media channel in the second display.

2. The system of claim 1, wherein the navigation module is further configured to:
cause movement of the second display based on the input data, the input data comprising a direction and velocity of movement on the touch-enabled surface.

3. The system of claim 2, wherein the input data comprises data pertaining to a gesture performed by a user on the touch-enabled surface of a remote control device.

4. The system of claim 2, wherein the input data comprises data pertaining to a gesture performed by a user on the touch-enabled surface of a display.

5. The system of claim 2, wherein the input data comprises data pertaining to a gesture performed by a user from an edge of the touch-enabled surface.

6. The system of claim 1, wherein the second display, during traverse over the first display, comprises a background image associated with the second live media content of the second media channel and an identifier of the second media channel.

7. The system of claim 1, wherein the second display, during traverse over the first display, comprises the second live media content of the second channel.

8. The system of claim 1, wherein the navigation module is configured to:
cause the second display to traverse over the first display in the direction corresponding to a movement on the touch-enabled surface;
determine that the second display has replaced the first display;
retrieve the second live media content of the second channel in response to the second display replacing the first display; and
replace the description of the second live media content of the second channel with the second live media content of the second channel in response to the second display replacing the first display.

9. The system of claim 1, wherein the navigation module is configured to:
access description information pertaining to the second live media content of the second media channel.

10. The system of claim 1, wherein the navigation module is configured to:
generate a first panel comprising the first live media content of the first media channel;
generate a second panel comprising a description of the second live media content of the second media channel; and
cause the second panel to traverse over the first panel and cover the first panel in response to the input data.

11. A method, comprising:
generating, using at least one processor, a first display comprising a first live media content of a first media channel;
detecting input data from a touch-enabled surface;
causing a second display to traverse over the first display in response to the input data, the second display, during traverse, comprising a description of a second live media content of a second media channel; and
generating the second live media content of the second media channel in the second display.

12. The method of claim 11, further comprising:
causing movement of the second display based on the input data, the input data comprising a direction and velocity of movement on the touch-enabled surface.

13. The method of claim 12, wherein the input data comprises data pertaining to a gesture performed by a user on the touch-enabled surface of a remote control device.

14. The method of claim 12, wherein the input data comprises data pertaining to a gesture performed by a user on the touch-enabled surface of a display.

15. The method of claim 12, wherein the input data comprises data pertaining to a gesture performed by a user from an edge of the touch-enabled surface.

16. The method of claim 11, wherein the second display, during traverse over the first display, comprises a background image associated with the second live media content of the second media channel and an identifier of the second media channel.

17. The method of claim 11, wherein the second display, during traverse over the first display, comprises the second live media content of the second channel.

18. The method of claim 11, further comprising:
causing the second display to traverse over the first display in the direction corresponding to a movement on the touch-enabled surface;
determining that the second display has replaced the first display;
retrieving the second live media content of the second channel in response to the second display replacing the first display; and
replacing the description of the second live media content of the second channel with the second live media content of the second channel in response to the second display replacing the first display.

18. The method of claim 11, further comprising:
accessing description information pertaining to the second live media content of the second media channel.

19. The method of claim 11, further comprising:
generating a first panel comprising the first live media content of the first media channel;
generating a second panel comprising a description of the second live media content of the second media channel; and
causing the second panel to traverse over the first panel and cover the first panel in response to the input data.

20. A non-transitory machine-readable storage medium storing a set of instructions that, when executed by at least one processor, causes the at least one processor to perform operations comprising:
generating a first display comprising a first live media content of a first media channel;
detecting input data from a touch-enabled surface;
causing a second display to traverse over the first display in response to the input data, the second display, during traverse, comprising a description of a second live media content of a second media channel; and
generating the second live media content of the second media channel in the second display.
